(19) United States
(12) Patent Application Publication
(10) Pub. No.: US 2008/0089998 A1
(43) Pub. Date: Apr. 17, 2008

(54) FORMULATION AND METHOD OF MANUFACTURING AN ALMOND LEAF FODDER

(76) Inventor: Chin-Pao Chou, Shafter, CA (US)

Correspondence Address: CHRISTIE, PARKER & HALE, LLP, PO BOX 7068, PASADENA, CA, 91109-7068, US

(21) Appl. No.: 11/550,286

(22) Filed: Oct. 17, 2006

(51) Int. Cl. A23K 1/00

(52) U.S. Cl. 426/635

(57) ABSTRACT

An improved animal feed or fodder formulation for grazing animal is provided. The animal feed is formulated such that a significant portion of the nutrient is derived from almond leaves or almond leaf by-products. The animal feed formulation may be used on any grazing type of livestock including, cattle, sheep, goats, horses, or pigs. The formulation may also be used in a number of different feed types.

### FIELD OF THE INVENTION

The current invention is directed generally to an improved animal feed; and more particularly to an animal feed at least partially comprising almond leaf.

### BACKGROUND OF THE INVENTION

In agriculture, fodder or animal feed is any foodstuff that is used specifically to feed livestock, such as cattle, sheep, chickens and pigs. Although some fodder is of animal origin, most fodder is made from plants. Typical fodder plants include grasses, such as rye, bermuda, timothy and danthonia; grains, such as corn, oats, wheat and millet; brassicas, such as kale, rapeseed, rutabaga and turnip; and other materials such as soybean, clover and alfalfa.

One of the drawbacks of most of these conventional plant based fodders is that that they generally are nutrient deficient. To supplement these nutrient deficient fodder materials farmers often resort to expensive supplements, or to the addition of meat and bone meal. The use of these animal by-products has recently been identified as the principal source of mad cow disease in livestock, a disease that is caused by prion contamination in the meat and/or bone meal, and exposure to which is also associated with the onset of Creutzfeldt-Jacob disease in humans. Because of the danger to consumers, the identification of just a single of case of mad cow disease in the United States in late 2003 caused a number of countries, including the countries of the European Union, Canada, China, Mexico and Japan, to ban the import of beef from the United States. The associated lost sales from this ban has cost U.S. farmers over one billion dollars in the past three years. Unfortunately, because of the lack of inexpensive alternatives, some animal producers continue to use animal by-products as a supplemental nutrient for animal fodder.

In light of increasing consumer awareness of the danger associated with the use of these animal by-products, and the lack of suitable alternative sources of nutrients, a clear need exists to find a cheap and safe nutrient rich material for use in animal fodder.

### SUMMARY OF THE INVENTION

The current invention is directed to an animal fodder at least partially comprising almond leaves or almond leaf by-products.

In one embodiment the animal fodder is comprised of at least 70% almond leaf material.

In another embodiment, the inventive fodder material is pressed into pellets.

In still another embodiment, alfalfa is used as a filler material for the fodder, and in one such embodiment the alfalfa material comprises up to 30% of the fodder.

In yet another embodiment, the animal feed includes additional nutrient supplements, such as recommended vitamins and enzymes.

In still yet another embodiment, the animal feed of the current invention is formulated for use on any suitable livestock, such as cattle, sheep, goats, horses and pigs.

### DETAILED DESCRIPTION OF THE INVENTION

The current invention is directed to an improved animal feed or fodder formulation, and specifically to an animal feed formulation in which a significant portion of the nutrient is derived from almond leaves or almond leaf by-products.

As background, currently almond leaves are seen as a nuisance and as a potential hazard to almond orchards. Specifically, fallen almond leaves are notorious for being particularly attractive to insects, which when present often also infest and destroy the nearby almond trees and nuts. As such, each year almond farmers spend a considerable amount of money and time disposing of almond leaves as a waste product. Meanwhile, vast tracts of cultivated land are devoted to the production of nutrient deficient animal fodder materials such as hay, clover, and alfalfa, materials, which must then be supplemented with other non-natural materials to obtain an optimal feed material for animals.

It has now been discovered that the reason almond leaves are attractive to insects is that they are naturally very protein and nutrient rich. In light of this discovery, an animal feed has been formulated for use with most grazing animals that at least partially comprises almond leaves, or almond leaf materials as the principal source of protein and other nutrients. The almond leaf material may comprise a simple nutritive additive to standard animal fodders in concentrations as low as 5 to 10%, or alternatively may comprise the bulk of the fodder material up to a concentration of 95% almond leaf.

As discussed above, a number of suitable formulations may be used, however, in one preferred embodiment the almond leaf material comprises up to 70% by volume of the animal fodder. In such an embodiment, the remainder of the feed may include other fodder materials, additives, coating agents, binding agents or fillers.

Suitable additive fodder materials include, for example, grasses, such as rye, bermuda, timothy and danthonia; grains, such as corn, oats, wheat and millet; brassicas, such as kale, rapeseed, rutabaga and turnip; and other materials such as soybean, clover and alfalfa.

Suitable additives may include, for example amino acids such as methionine and lysine, vitamins and also other nutritional or medicinal additives.

Suitable coating agents include copolymers of vinylpyridine and styrene with a hydrophobic substance, preferably stearic acid, a water-insoluble polymer, for example ethylcellulose, chitosan and/or zein, combined with a hydrophobic substance, preferably stearic acid,

Suitable binding agents include the class of hydrocolloids, preferably water-soluble derivatives of cellulose, more preferably carboxymethylcellulose, hydroxypropylcellulose, hydroxyethylcellulose, and hydroxymethylcellulose; the class of natural or synthetic polysaccharides, preferably gum arabic, gum tragacanth, carrageenates, dextrins, starch, xanthan gum, and alginates; sugars; molasses and vinasses; lignosulphonates; grain flours or seaweed meal; crystallizable inorganic compounds, preferably lime, plaster, sodium silicate, calcium carbonate and silica; gelatins; tanned proteins; polyvalent cation salts of natural or synthetic polyacids; drying oils and mastics obtained by the combination of a drying oil and a filler; fatty acids and alcohols; hydrogenated vegetable and animal fats; glycerol esters; paraffin waxes; natural and synthetic waxes; and synthetic polymers, preferably polyethylene glycols and polyvinyl acetate. Among all the binding agents, the most preferred are molasses, vinasses, fatty acids, hydrogenated vegetable or animal fats, plaster and paraffin waxes. Some of these binding agents may also be used with crosslinking agents. Preferred crosslinking agents include aldehydes for proteins, and salts or oxides of di- or trivalent metals for alginates, xanthan gum, molasses, vinasses and other hardening or curing agents suitable for the binders as known to those skilled in the art.

Suitable fillers may include, for example inorganic mineral additives, preferably silica, silicates, talc, clays, calcium carbonates and phosphates; and additives derived from natural products, preferably grain flours, residues of the cereals, wood, brewery and fermentation industries (waste- or by-products), ground feed cakes, cellulose vegetable fibers, polysaccharides and sugars.

In addition, the animal feed of the current invention may take any suitable form including a mixture of whole almond leaves and other plant materials, such as might be formed into a bale or other suitable or pellets. When used in pellet form any suitable pelletizing technique may be utilized, including by extrusion of the feed mixture through a die or by alternative pelletization techniques. In such an embodiment, although any shape of pellet may be formed, the pellets are preferably in the form of rods, preferably cylindrical in shape, and having average sizes from about 4 to 100 mm in length. These pellet sizes are preferred because they are easy to handle and administer and because they are not dust-forming.

In short, pelletizing machines permit shaping by forcing a feed mixture through a perforated plate or die in the presence of steam. A feed mixture is passed through a perforated plate or die by means of a press. The press forces the feed mixture to be extruded through the holes in the perforated plate. On emerging from the perforated plate, the cylinders of feed mixture obtained are cut spontaneously or by a mechanical means. During the forced passage of the feed mixture through the die, products having low thermal resistance or mechanical strength undergo degradation due both to the pressure exerted and to the heat formed by friction and/or by the addition of steam. Steam promotes cohesion of the various ingredients of the base feed mixture. One exemplary disclosure of this process is provided in European patent application number EP 231,817 which describes a process for preparing “agglomerated feeds” based on vitamins or on compounds essential to human or animal health.

The present invention will be described more completely by means of the example which follows. This example is not to be considered limiting with respect to the invention, in particular with respect to either the formulation of animal feed used, or the type of animal the current animal feed may be used with.

### EXAMPLE

In one exemplary experiment, one formulation of the animal feed mixture of the current invention was tested against a standard pure alfalfa fodder. In the experiment twenty-five pairs of sheep and goat twin siblings were separated and put into two groups. The first group (Group A) was fed an animal feed formulation contain a mixture of 70% almond leaves and 30% alfalfa, and the second control group (Group B) was fed a pure alfalfa diet. Twins were used to ensure there was no genetic component to the observed growth results. Although the experiment used sheep and goats because of the increased incidence of twins, it is believed that the results would be applicable to other grazing animals as well.

The two groups were followed for several months and examined for differences in a number of morphological and behavioral criteria, including weight gain, coat quality, appetite and activity level. First, all animals tested, when given a choice, showed a preference for the inventive animal feed. Specifically, in one experiment the animals of Group A were presented with two separate containers: one containing a mix of almond leaves and alfalfa, and one containing pure alfalfa. The animals uniformly fed from the almond containing mixture preferentially. It is believed that the animals were drawn to the almond mix due to the higher protein levels present in these feed materials, higher protein levels that can be detected via the animal heightened sense of smell.

Moreover, from a morphological perspective, the animals of Group A showed an improvement in coat texture and thickness after only 1 week on the new diet. In addition, the animals of Group A gained on average about 5 lbs more than animals of Group B over the first two months of the study. Finally, the animals of Group A also showed increased activity levels over the entire length of the study. These results are summarized in Table 1, below.

TABLE 1
Comparative Animal Feed Study Results

| Observed Quality | Observed Difference | Time Frame |
|---|---|---|
| Weight Gain | Study group showed 5 lbs increase | ~two months |
| | in weight over Control group. | |
| Coat Quality | Study Group showed improved | ~one week |
| | texture and thickness of coat. | |
| Activity Level | Study Group showed increased | length of study. |
| | activity levels over Control group. | |
| Appetite | Study Group showed increased | length of study |
| | interest in food. | |

The inventive fodder formulation of the current invention has a number of advantages of prior are fodders:
It provides an excellent source of natural protein to both livestock, and indirectly humans in the form of healthier animals.
Because almond leaves are a waste product that are produced naturally, it can reduce feed costs, while simultaneously reducing costs associated with almond farming by eliminating the need to use costly pesticides.
It reduces pesticide use by removing the principal food source for most insects in almond orchards.
It creates a new economy around what was previously considered a waste product, namely almond leaves.

While this invention has been described in detail with reference to a certain preferred embodiments, it should be appreciated that the present invention is not limited to those precise embodiments. Rather, in view of the present disclosure which describes the current best mode for practicing the invention, many modifications and variations would present themselves to those of skill in the art without departing from the scope and spirit of this invention. In particular, it is to be understood that this invention is not limited to the particular animal feed formulation of animal species as such may vary, as will be appreciated by one of skill in the art. The scope of the invention is, therefore, indicated by the following claims rather than by the foregoing description. All changes, modifications, and variations coming within the meaning and range of equivalency of the claims are to be considered within their scope.

What is claimed is:

1. An animal feed formulation comprising at least one plant material, wherein at least a portion of said formulation is made from at least a portion of the leaf of an almond tree.

2. The animal feed formulation of claim 1, wherein the almond leaf may be whole or processed.

3. The animal feed formulation of claim 1, wherein the formulation further comprises a second plant material selected from the group consisting of grasses, grains, brassicas, soybean, clover and alfalfa.

4. The animal feed formulation of claim 1, wherein the formulation further comprises an additive selected from the group consisting of amino acids, vitamins and other nutritional or medicinal additives.

5. The animal feed formulation of claim 1, wherein the formulation further comprises a coating agent.

6. The animal feed formulation of claim 1, wherein the formulation further comprises a binding agent selected from the group consisting of hydrocolloids, natural or synthetic polysaccharides, sugars; molasses, vinasses, lignosulphonates, grain flour, seaweed meal; crystallizable inorganic compounds; gelatins; tanned proteins; polyvalent cation salts of natural or synthetic polyacids, drying oils, mastics; fatty acids, alcohols, hydrogenated vegetable or animal fats, glycerol esters, waxes, and synthetic polymers.

7. The animal feed formulation of claim 1, wherein the formulation further comprises a crosslinking agent selected from the group consisting of aldehydes, salts or oxides of di- or trivalent metal, xanthan gum, molasses, and vinasses.

8. The animal feed formulation of claim 1, wherein the formulation further comprises a filler selected from the group consisting of a silica, silicates, talc, clays, calcium carbonates, phosphates, grain flours, cereals, wood, ground feed cakes, cellulose vegetable fibers, polysaccharides and sugars.

9. The animal feed formulation of claim 1, wherein the formulation is in a pellet form.

10. The animal feed formulation of claim 1, wherein the pellet is rod shaped.

11. The animal feed formulation of claim 1, wherein the almond leaf material comprises at least 70% by volume of the formulation.

12. The animal feed formulation of claim 10, wherein the formulation further comprises alfalfa.
